(19) United States
(12) Patent Application Publication
(10) Pub. No.: US 2021/0075812 A1
(43) Pub. Date: Mar. 11, 2021

(54) A SYSTEM AND A METHOD FOR SEQUENTIAL ANOMALY REVEALING IN A COMPUTER NETWORK

(71) Applicant: ABC SOFTWARE, SIA, Riga (LV)

(72) Inventors: Pavels OSIPOVS, Riga (LV); Aivars ROZKALNS, Riga (LV); Arkadijs BORISOVS, Riga (LV); Andrejs JERSOVS, Riga (LV); Jurijs CIZOVS, Riga (LV); Jurijs KORNIJENKO, Riga (LV); Vitalijs ZABINAKO, Riga (LV)

(21) Appl. No.: 17/052,899

(22) PCT Filed: May 8, 2018
(86) PCT No.: PCT/IB2018/053187

§ 371 Date: Nov. 4, 2020

(51) Int. Cl. H04L 29/06; H04L 29/08

(52) U.S. Cl. CPC H04L 63/1425; H04L 67/142; H04L 67/146

(57) ABSTRACT

The present invention relates to a system and a method for sequential anomaly revealing in a computer network.

A method comprises the steps of receiving a log-file on activities of a user in the computer network; optional evaluation of each state in a session in a quarantine mechanism; multiple criteria evaluation of states of not quarantined states of the sessions or multi-state sessions in a session evaluation mechanism; and building and updating individual and group models.

The system comprises a sequential anomaly revealing platform connected to the data hub and configured to reveal sequential anomalies in signals received from the data. The sequential anomaly revealing platform further comprises session evaluation and anomaly detection mechanism, individual and group models building and updating mechanisms, and optional multi-state transformation module and a quarantine module.

### FIELD OF THE INVENTION

The present invention relates to a system and a method for sequential anomaly revealing in a computer network.

### BACKGROUND OF THE INVENTION

The prior art discloses various threat detection and behavioural analysis methods and systems. U.S. Pat. No. 6,370,648 discloses a system for Detecting harmful or illegal intrusions into a computer network or into restricted portions of a computer network that uses statistical analysis to match user commands and program names with a template sequence. Discrete correlation matching and permutation matching are used to match sequences.

Another U.S. Pat. No. 9,516,053 discloses a security platform that employs a variety techniques and mechanisms to detect security related anomalies and threats in a computer network environment. The security platform is “big data” driven and employs machine learning to perform security analytics. The security platform performs user/entity behavioural analytics to detect the security related anomalies and threats.

US patent application publication No. US2016/0342453 discloses a system and methods for anomaly detection wherein a log sequence monitoring is used in an environment or other system. A cloud administrator or other such entity can use log sequence monitoring tools and/or data to pinpoint a root cause of an anomaly identified through log monitoring. Once the root cause has been determined, the administrator takes appropriate remedial action on the faulty component, service, or other such cause. Similar method and system is disclosed in the U.S. Pat. No. 8,495,429.

### SUMMARY OF THE INVENTION

The present invention is a system and a method for sequential anomaly revealing in a business, manufacturing, organizational, etc. processes, which is robust to a fickle and dynamical environment.

A method of sequential anomaly revealing in a computer network includes series of steps in result of which an anomaly in a use of the computer network can be detected. The computer network in a sense of this disclosure might be any Internet of Things network or system, or any other networked device on which a method of sequential anomaly revealing is performed. The computer network may be any environment—natural or artificial surrounding, in which various types of processes are passing or performing, which in turn is analysed for the sequential anomalies by the present invention. The environments may be computer information system—e-media for storing and translating of observed signals.

The first step in the method is receiving a log file on activities of a user in the computer network or on any other computer device. For example, log messages are typically unstructured free-form text. strings, which can record events or states of interest and capture a system administrators' intent. Input data or anonymized process flow—time sequence of any kind of events, which take place in computer information system (not just internet traffic). For example, users activity, bots activity, sensors values, recognized elements in video streams, etc. Normally events are storing in log-files or relational tables of computer information system database.

After receipt of a log file, activities of the user in the log file are transformed into sessions S. Each session S comprises data on actions made by the user of the computer network. Each session S comprises multiple states or activities as shown in an example below:
time eventId entityId groupId
   where
   time—the time of event appearance in computer information system;
   eventId—predefined and permanent/constant identifier of an event, which may be happened in computer information system;
   entityId—predefined and permanent/constant identifier of a user or bot, which raised the event and
   groupId—predefined and permanent/constant identifier of aggregation of users or bots.

Session of single-element states, S—a sequence of events or actions, made by single user or bot (entityld). Usually, session is starting by some kind of head element (for example “login”) and finishing by some kind of ending element (for example, “logout”). SARP supports cases when start and/or ending elements are absence. The structure of a session S is shown in the following example:
s₁, s₂, s₃, s₄, . . .

Session of multi-element states, Ŝ—a sequence of multi-events or multi-actions, made by single user or bots is shown in the following example:
[symbol] , [symbol] , [symbol] , [symbol] , . . .

The system comprises a data adapter configurable by user mechanism of log-file or log-table data transformation to the sessions S. Obtained sessions are stored in sessions and models storage database, which is the next step after receipt of log files.

In another embodiment, the log files and anonymized before sending them for analysing in a sequential anomaly revealing platform.

The method further comprises as step of multi-state transformation of the session S, wherein the session S is sequentially framed into a multi-state session S and sent back to the session and model storage.

The next step of the method in a step of evaluation of each state in the session S in a quarantine mechanism. In the quarantine mechanism a comparison is performed for each state in the session S or in the multi-state session S on belonging to existing vocabulary. When present state of the session S or the multi-state session S does not belong to the existing vocabulary, the present state is added to the existing vocabulary as a state in quarantine. When a same state in quarantine is recognized in other analysed states of the session S or the multi-state session within a predetermined period of time and/or within predetermined states of the sessions S or the multi-state sessions Ŝ from other users of the computer network, the present state is recognized as accepted state.

After evaluation of each state in the session S, the quarantine mechanism is sending evaluated states and/or sessions S or multi-state sessions Ŝ to the session and model storage. Each state is marked as the state in quarantine or as the accepted state.

The method further comprises a multiple criteria evaluation of not quarantined states of the sessions S or multi-state sessions Ŝ in a session evaluation mechanism. Accepted states of the sessions S or multi-state sessions Ŝ are compared to behavior models (e.g. Markov chain model) or set of criteria, in result of which each state of the session S and/or Ŝ obtains a weighted value thereof.

The next step includes comparison of obtained weighted values of the states of the session S and Ŝ to a predetermined anomaly threshold. When present states of the session S or S exceeds the predetermined anomaly threshold for individual behavior model or group behavior model (based on groupId attribute of session state data), signalizing is issued to an administrator of the computer network about anomaly in the present states of the session S or Ŝ.

Accepted states of the sessions S or Ŝ are sent to a model building mechanism, wherein accepted states are used to update existing models for multiple criteria evaluation. The model building mechanism comprises individual behavior model and group behavior model.

A predefined set of criteria for multiple criteria evaluation of each session is selected from the group comprising: Markov chain model; containing in an interval; mean for multiple values in an interval; sub-set function; multilayer perceptron and self-organizing maps.

A system for sequential anomaly revealing in a computer network for performing aforementioned method comprises at least one environment, in which various types of processes are performed, wherein later on the processes are analysed on anomalies. The system further comprises at least one information system connected to the environment and configured to storing and translating signals received from the at least one environment. The system further comprises a data hub connected to each information system of the computer network.

The system is characterized in that it further comprises a sequential anomaly revealing platform connected to the data hub and configured to reveal sequential anomalies in signals received from the data. The sequential anomaly revealing platform further comprises a multi-state transformation module and a quarantine module.

A sequential anomaly revealing method and system employs techniques and mechanisms to detect process anomalous evolution in an observed environment, which has property of changing structure, rules, physics, etc. The method and the system is aimed for sequential and combined kinds of anomaly detection at the business layer of the environment. It employs computational intelligence algorithms to build behavioural models and update or adapt it according to behaviours drifting of entities in the environment. Implemented techniques automate initial model building, therefore the manual design of anomalous activity patterns is not requiring. The sequential anomaly revealing method and system is designed for non-invasive interaction with host computer information system of the observed environment, which means no code injections to the host computer information system required. The revealing mechanisms support anonymized or obfuscated data processing and thus providing the customer data confidence. The key feature of the platform is providing of fully automated mechanisms for correct processing of the observed environment structural changes and thus avoiding of false alarms. A sequential anomaly revealing method and system is capable to function both in single and multiple environments, providing detailed reports and controlling tools.

### BRIEF DESCRIPTION OF THE DRAWINGS

The following invention is described in more detail using the following figures:

FIG. 1 illustrates a general interaction scheme of a host information system and an anomaly identification platform.

FIG. 2 illustrates a general architecture of a sequential anomaly revealing platform.

FIG. 3 illustrates a general architecture of a quarantine mechanism as seen in FIG. 2.

FIG. 4 illustrates a general architecture of multiple-criteria evaluation mechanism as seen in FIG. 2.

FIG. 5 illustrates a multi-state transformation mechanism as seen in FIG. 2.

FIG. 6 illustrates one embodiment of a multi-state transformation mechanism in a process of sequential framing of states within each session.

### DETAILED DESCRIPTION OF THE INVENTION

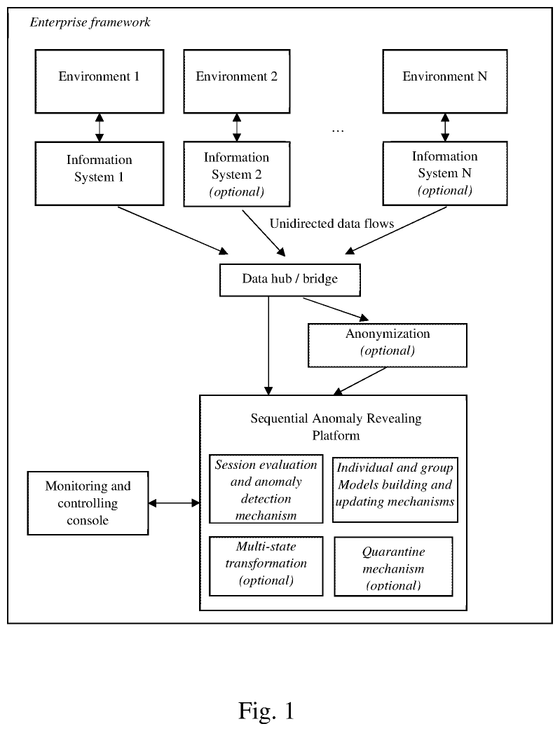

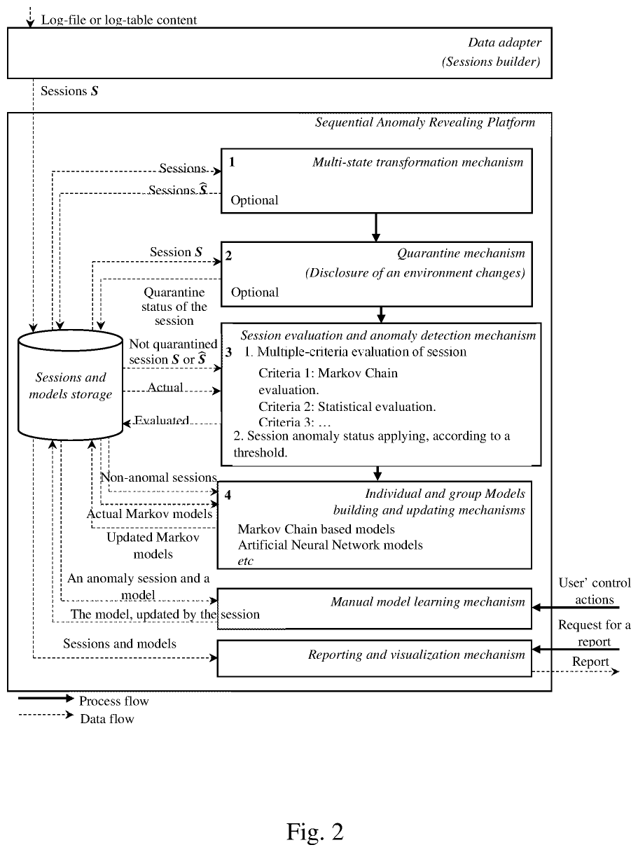

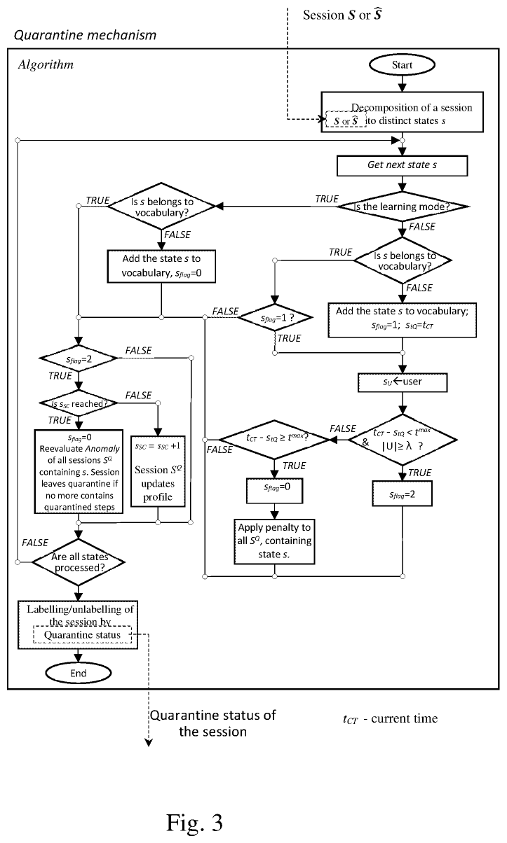

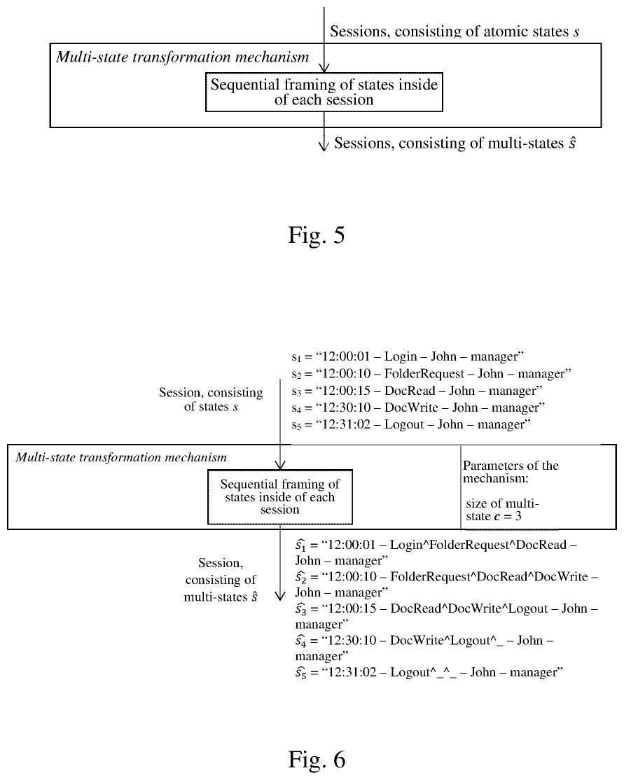

The general interaction of a host information system and an anomaly identification platform (as shown in FIG. 1) implies presence of at least one IT system (or multiple systems—Information System 1 . . . Information System N) which processes and stores data regarding at least one business/production environment (or multiple environments Environment 1 . . . Environment N). The relevant data about action sessions from according IT systems log-file is retrieved via technical connection point “data hub/bridge” (it is shown as component “Data adapter” in FIG. 2) which enables transferring of information from target system to the entry of anomaly identification platform. An optional step “Anonymization” is executed in case if the data being retrieved is sensitive and there is a need for depersonalization or obfuscation in order to ensure privacy and non-disclosure of such information. The output from “data hub/bridge” in form of sequences of events serves as the input for the anomaly identification platform which ensures storage, building of behavior models and verification of new sequences of events against these behavior models as shown in details in FIG. 2. An anomaly identification platform operator oversees the process of model building and verification via monitoring and controlling console. The platform is also supplied with additional optional mechanisms of “quarantine” (see FIG. 3) and multi-state transformation (see FIG. 5 and FIG. 6) for effective data processing.

The general architecture of a sequential anomaly identification platform (as shown in FIG. 2) consists of multiple modules which are interconnected by data and process flows. The log-file data is interpreted by the adapter which performs transformation to the native format of sessions S and saves these sessions to the central storage. Two optional mechanisms can be enabled for improved anomaly identification—the Multi-state transformation mechanism [1] (see FIG. 5 and FIG. 6) and the Quarantine mechanism [2] (see FIG. 3) which are described in the following text. All captured sessions (in case of enabled quarantine—only those sessions which are not under quarantine) are inspected in Session evaluation and anomaly detection mechanism [3], based on one or many criteria, current models (behavioral profiles) and a pre-configured alert threshold. In case if particular session is non-anomal, according data is used for building and updating of individual and group (based on groupId attribute of session state data) models (behavioral profiles) in mechanism [4]. In case if particular session is evaluated as anomaly, the user of the Platform can provide manual input and enforce the non-anomal state via Manual model learning mechanism. Also, the user can obtain reports and visualization data from the Platform, regarding current state of captured sessions and actual models.

The Quarantine mechanism (as shown in FIG. 3) is necessary to prevent the case when the set of all possible states is enhanced (e.g., via introduction of new functionality in the target system) and, as a result, the method of anomaly revealing, without knowledge about typical usage scenarios of newly introduced states, would detect multiple false-positive cases of abnormal behavior in sessions of different users.

General approach of quarantine mechanism: the platform maintains a “vocabulary” of all known states, which is being filled while the system is in training mode. When user performs unknown step X (which is not in the vocabulary), the “quarantine” mode for this session is enabled for a time which is defined by a parameter t^{max}. t^{max} is predefined parameter describing allowable time of stay in quarantine. During this time, the quarantine algorithm checks whether this new state also appears in new sessions of at least λ number of other users. λ is predefined parameter describing amount of users, required for state to be leaving the quarantine. If this happens, the assumption is made, that the system has a new functionality state X and for each user profile additional education for such sessions occurs, until a minimum number of sessions s_{SC} is achieved regarding this certain state X. s_{SC} is also predefined parameter describing a number of sessions for additional learning for the quarantine mechanism.

Data structures: “Vocabulary” is a collection of action state identifiers, where each action state has property S_{flag}={0,1,2} where:
0—an accepted/proved state;
1—a state under quarantine;
2—a state for forced learning.

Data structures comprise a vocabulary of states (see FIG. 3), wherein in one embodiment the vocabulary of the states may be as follows:

| | | | |
|---|---|---|---|
| s₁ | s₂ | . . . | s_{V} |

Structure of a state s may comprise the following parameter:
id flag tQ SC
   where
   id is state identifier;
   flag is state property value as described above;
   tQ is a time of a state entrance into the quarantine;
   U is a list of users who got in the state; and
   SC is a session count containing the state.

The data structure may comprise an array of stand aside sessions:

| | | | |
|---|---|---|---|
| S^{Q}₁ | S^{Q}₂ | . . . | S^{Q}_{N} |

The algorithm of quarantine mechanism:

a) while in the learning mode, every state in user sessions is checked against a vocabulary, if such a state is not present there, then it is inserted in the vocabulary with the property S_{flag}=0.
b) while in analysis mode, every state of the user sessions is checked against a vocabulary, if such a state is not there, then it is inserted in the vocabulary with the property S_{flag}=1 and this session receives status “Quarantined”.
c) if, during the time interval t^{max} at least a number of users λ performs in their sessions the same step (the time interval t^{max} is forcibly stopped as soon as λ is reached), then:
1. For this certain state property S_{flag} becomes 2.
2. Additional learning is performed, which is controlled by the parameter s_{SC}, during which, any session, where this new state is encountered, is used for learning and this session receives status “Learning for new functionality”.
3. After reaching the necessary number of s_{SC}, the suspiciousness of all according sessions with a status “Learning for new functionality”, are recalculated, and also, the property S_{flag} of according step in the vocabulary is set equal to 0.
   d) if the condition on t^{max} and λ fails (i.e., it is not a new functionality), then:
1. For this certain state S_{flag} becomes 0.
2. The suspiciousness of all sessions that are had been quarantined due to this state, are recalculated with penalties for each such transition.

Each state in session is treated and analyzed independently of others in case if the user session contains multiple states under quarantine. In this case, final operations with sessions are committed only when all states under the quarantine are processed according to the aforementioned algorithm.

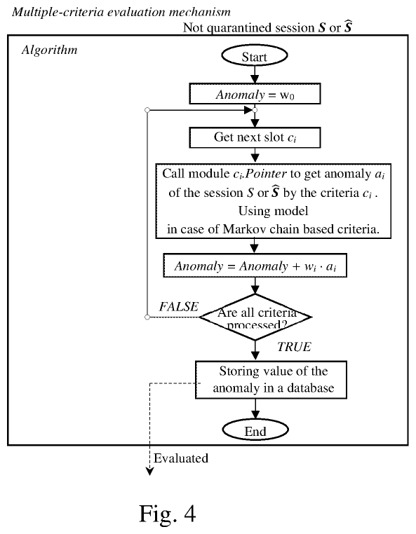

The Multiple-criteria evaluation mechanism (as shown in FIG. 4) is part of the Session evaluation and anomaly detection mechanism (as shown in FIG. 2). This mechanism enables ability of the Anomaly Revealing Platform to analyze sessions regarding multiple criteria—the overall anomaly is calculated within slots (criteria) of the following structure:

| | | | |
|---|---|---|---|
| c₁ | c₂ | . . . | cₙ |

where each slot has attributes:
Id Type Pointer
   and each slot is weighted with according coefficient:

| | | | | |
|---|---|---|---|---|
| w₀ | w₁ | w₂ | . . . | wₙ |

The content of each slot can be as follows:
Markov chain model;
containing in interval;
mean for multiple values in an interval;
sub-set function;
custom equations;
multilayer perceptron;
self-organizing maps.

The algorithm of multi-criteria evaluation mechanism:

The Anomaly level of particular session is set to an initial value.

While there are unprocessed slots left, proceed as follows:
a) Get the next slot cᵢ;
b) Call a Pointer of the slot to get anomaly aᵢ of the session S (or Ŝ in case of multi-state session) by the criteria cᵢ (in case of Markov chain criteria according model will be used for analysis);
c) Calculate anomaly at the current step as Anomaly=Anomaly+wᵢ·aᵢ

If the last slot was processed—store the current value of Anomaly as the final result of multiple-criteria analysis.

The Multi-state transformation mechanism (as shown in FIG. 5) performs transformation of sessions with atomic states to sessions containing multi-steps. Such transformation is performed via framing—a process of dividing set of states of the session to create modified instance of session, which contains concatenated states. One embodiment of a multi-state transformation mechanism is shown in FIG. 6. The variable parameter—size of multistate c determines the exact result of output session, e.g. if c=3, then original session with atomic states Login→FolderRequest→DocRead→DocWrite→Logout transforms to concatenated multi-state session Login\hat{ }FolderRequest\hat{ }DocRead→FolderRequest\hat{ }DocRead\hat{ }DocWrite→DocRead\hat{ }DocWrite\hat{ }Logout→DocWrite\hat{ }Logout\hat{ }_→Logout\hat{ }_\hat{ }_ (where symbol “A” is the concatenator and symbol “_” denotes a void state). This approach enables better distinguishing and semantic control for semantic of session states, which, in turn, enables better functioning of Sequential Anomaly Revealing Platform as a whole.

Given invention is not restricted by embodiments of invention described herein. Those skilled in the art can change or modify given embodiments without departing from the spirit and scope of the invention.

1. A method of sequential anomaly revealing in a computer network, the method comprising:
(a) receiving a log-file on activities of a user in the computer network;
(b) transforming activities of the user in the log-file into sessions (S), wherein each session (S) comprises data on actions made by the user of the computer network;
(c) sending of sessions (S) to a session and model storage;
(d) multi-state transformation of the session (S), wherein the session (S) is sequentially framed into a multi-state session (Ŝ) and sent back to the session and model storage;
(e) evaluation of each state in the session (S) in a quarantine mechanism, wherein the quarantine mechanism comprises the following steps:
(e1) comparison of each state in the session (S) or in the multi-state session (Ŝ) on belonging to existing vocabulary;
(e2) when present state of the session (S) or the multi-state session (Ŝ) does not belong to the existing vocabulary, the present state is added to the existing vocabulary as a state in quarantine;
(e3) when a same state in quarantine is recognized in other analysed states of the session (S) or the multi-state session (Ŝ) within a predetermined period of time and/or within a predetermined states of the sessions (S) or the multi-state sessions (Ŝ) from other users of the computer network, the present state is recognized as accepted state for additional learning;
(f) sending of evaluated states and/or sessions (S) or multi-state sessions (Ŝ) in step e) to the session and model storage, wherein each state is marked as the state in quarantine or as the accepted state;
(g) multiple criteria evaluation of not quarantined states of the sessions (S) or multi-state sessions (Ŝ) in a session evaluation mechanism, wherein accepted states of the sessions (S) or multi-state sessions (Ŝ) are compared to behavior models or set of criteria in result of which each state of the session (S; Ŝ) obtains a weighted value thereof;
(h) comparison of obtained weighted value of the states of the session (S; Ŝ) to a predetermined anomaly threshold;
(i) when present state of the session (S; Ŝ) exceeds the predetermined anomaly threshold for individual behavior model or group behavior model (based on groupId attribute of session state data), signalizing to an administrator of the computer network about anomaly in the present state of the session (S; Ŝ);
(j) sending of accepted states of the sessions (S; Ŝ) to a model building mechanism (both individual behavior model and group behavior model), wherein accepted states are used to update existing models for multiple criteria evaluation.

2. The method according to claim 1, wherein predefined set of criteria for multiple criteria evaluation of each session (S) is selected from the group comprising: Markov chain model; containing in an interval; mean for multiple values in an interval; sub-set function; multilayer perceptron and self-organizing maps.

3. The method according to claim 1, wherein the session (S) is anonymized before sending them to quarantine mechanism.

4. A system for sequential anomaly revealing in a computer network for performing the method according to claim 1, wherein the system comprising:
at least one environment (EN) in which various types of processes are performed, wherein later on the processes are analysed on anomalies;
at least one information system (IS) connected to the environment and configured to store and translate signals received from the at least one environment (EN);
a data hub (DH) connected to each information system (IS) of the computer network;
a sequential anomaly revealing platform (SARP) connected to the data hub (DH) and configured to reveal sequential anomalies in signals received from the data (DH), wherein the sequential anomaly revealing platform (SARP) further comprises:
a multi-state transformation module (MSTM) and
a quarantine module (QM).
